(19) United States
(12) Patent Application Publication
(10) Pub. No.: US 2005/0059291 A1
(43) Pub. Date: Mar. 17, 2005

(54) APPARATUS AND METHOD FOR ASSEMBLING ELECTRONIC CABLES TO PLUGS AND WALL JACKS

(76) Inventor: Keith Alan Wood, Boca Raton, FL (US)

Correspondence Address: JOHN C. SMITH, ESQ., 4800 NORTH FEDERAL HIGHWAY, SUITE A-207, BOCA RATON, FL, 33431, US

(21) Appl. No.: 10/710,240

(22) Filed: Jun. 29, 2004

Related U.S. Application Data
(60) Provisional application No. 60/481,368, filed on Sep. 12, 2003.

(51) Int. Cl. H01R 4/24

(52) U.S. Cl. 439/418

(57) ABSTRACT

A connector plug with an integral circuit board for rerouting wires, and a method of attaching wires from a multi-wire cable to an RJ-45, RJ-11, connector plug or any other similar jack without the requirement to manually separate, sort, and route individual wires to specific pins. The standard arrangements of wires within the cable, which are in UTP color code, are attached to the jack in the same order that they are arranged within the cable. The circuit board within the connector is interposed between the pins on the connector, which are connected to the wires, and the I/O connector pins on the other end of the connector, which attach to wall jacks or other devices. The circuit board reroutes the data pat of the wires so that the wires, which were attached to the connector and cable order, are automatically rerouted to the correct output pin order. This eliminates the need to manually reorder the wires when they are connected to the connector and substantially reduces the amount of time required to attach the wires in a cable to the connector plug.

### BACKGROUND OF INVENTION

1. Technical Field

The present invention relates to electronic cables and an improved method of assembling them. In particular, it relates to an improved method of assembling electrical connectors to wiring by using an improved wiring structure, new connector and wall jack structures for RJ-45 connectors, and other multi-wire connectors, specialized assembly tools, and a new method of fabrication.

2. Background

Today, virtually every building, both residential and commercial, has at least one form of multi-lead electronic cable. These cables have been classified as CAT-3, CAT-5, CAT-5E and CAT-6. In residential areas the standard RJ-11 connectors are used to provide telephone communications links. More recently, with the on going development of computer networks, larger connectors having a greater number of wires have been developed to accommodate the high data rates required by computer networks. Currently, many networks and business phone systems use the standard RJ-45 connector to provide the necessary number of leads to manage computer network data flow. In addition to commonly used connectors such as RJ-45 and RJ-11, any number of other custom jacks can be fabricated to suit a particular purpose, regardless of the number of leads used.

In regard to the RJ-45 connector, the current connector configuration uses color-coded wires. The color code configuration for an RJ-45 Ethernet plug is as follows:

The data cable used with an RJ-45 plug is an eight-conductor data cable. It is well-known in the art and is commercially available as Cat 3, Cat 5, Cat 5E or Cat 6 cables. Each of these cables contain 4 pairs of wires. Each pair consists of a solid color wire and a second striped wire which uses white in combination with the color of the other wire in the pair. Each of the wires in a given pair is twisted together. To maintain reliability on Ethernet, it is preferred to untwist them the minimal amount prior to attachment to a plug. Typically, the length of the twisted portion is about 1/4inch.

When used in conjunction with Ethernet networks, the pairs designated for 10/100 Base-T Ethernet are orange and green. The other two pairs, brown and blue, are unused. The connections shown are specifically for an RJ-45 plug. The wall jack may be wired in a different sequence because the wires may be crossed inside the jack. The jack should preferably come with a wiring diagram or at least designate pin numbers that you can match up to the color code below.

There are two wiring standards for these cables, called T-568A and T-568B. They differ only in pin assignments, not in uses of the various colors. FIG. 1 shows both standards. With the T-568B specification the orange and green pairs are located on pins 1, 2 and 3, 6 respectively. The T-568A specification reverses the orange and green connections, so that the blue and orange pairs are on the center 4 pins, which makes it more compatible with the Telco voice connections. T-568A is intended to be the standard for new installations, and T-568B is the alternative. However, a majority of the off-the-shelf data equipment and cables are currently wired to T568B. The Pin Number Designations and wiring layouts for both standards are illustrated in FIGS. 2A-D. FIGS. 2A-B illustrate the T-568A specification, and FIGS. 2C-D illustrate the T-568B specification.

PIN number designations and the wire colors for the T-568A specification

| Pin | Color | Pair | Description |
|---|---|---|---|
| 1 | white/green | 3 | RecvData + |
| 2 | green | 3 | RecvData − |
| 3 | white/orange | 2 | TxData + |
| 4 | blue | 1 | Unused |
| 5 | white/blue | 1 | Unused |
| 6 | orange | 2 | TxData − |
| 7 | white/brown | 4 | Unused |
| 8 | brown | 4 | Unused |

PIN number designations and the wire colors for the T-568B specification

| Pin | Color | Pair | Description |
|---|---|---|---|
| 1 | white/orange | 2 | TxData + |
| 2 | orange | 2 | TxData − |
| 3 | white/green | 3 | RecvData + |
| 4 | blue | 1 | Unused |
| 5 | white/blue | 1 | Unused |
| 6 | green | 3 | RecvData − |
| 7 | white/brown | 4 | Unused |
| 8 | brown | 4 | Unused |

Note:
Odd pin numbers always use striped wires.

Straight-Through vs Cross-Over:

In general, the patch cords that you use with your Ethernet connections are “straight-through,” which means that Pin 1 of the plug on one end is connected to pin 1 of the plug on the other end (for either standard). The only time you cross connections in 10BaseT is when you connect two Ethernet devices directly together without a hub or connect two hubs together. Then you need a “cross-over” patch cable, which crosses the transmit and receive pairs. An easy way remember how to make a cross-over cable is to wire one end with the T-568A standard and the other with the T-568B standard.

Termination:

UTP cables are terminated with standard connectors, jacks and punch downs. The jack/plug is often referred to as a “RJ45,” but that's a designation for the “modular 8 pin connector” terminated with a USOC pin out used for telephones. The male connector on the end of a patch cord is called a “plug”and the receptacle on the wall outlet is a “jack.” The UTP color code layout of twisted wire pairs is illustrated in FIG. 3.

The cable pairs are color coded as follows: Pair 1 is white-blue/blue, Pair 2 white-orange/orange, Pair 3 is white-green/green, and Pair 4 is white-brown/brown.

In LANs, as specified by the 568 specification, there are two possible pin outs, called T568A and T568B, that differ only in which color coded pairs are connected. In particular, pairs 2 and 3 are reversed. Either configuration works equally well, as long as they are not mixed. If only one version is used, problems will be appointed, but if 568 specification types A and B are mixed in a cable run, wiring errors due to crossed pairs will result.

FIG. 4A illustrates a plug wired in a T-568B configuration, and FIG. 4B illustrates a plug wired in a T-568B configuration.

FIG. 5 illustrates the wiring connection to the back of a jack. Jacks usually have punch downs on the back or can be terminated without punch downs using special manufacturer's tools or even a cover for the connector. Again, the twists must be kept as close to the receptacle as possible to minimize crosstalk.

Note that Cat 3 jacks and all plugs are going to use these color codes. However, Cat 5 jacks have internal connections that continue the twists as close to the pins in the jacks as possible. Thus the pin out on the back of the jacks will not usually follow these layouts. The color codes on the back of the jacks must always be followed to insure proper connections.

Crossover Cables:

Normal cables that connect a PC/NIC card to a hub are wired straight through. That is pin 1 is connected to pin 1, pin 2 to pin 2, etc. However, if you are simply connecting two PCs together without a hub, you need to use a crossover cable made by reversing pair 2 and 3 in the cable, the two pairs used for transmission by Ethernet. The easy way to make a crossover cable is to make one end to T568A color coding and the other end to T568B. Then the pairs will be reversed.

How to Make A Cable Connection

1—Strip the cable sheath a min of 20 mm from the end of the conductors.

2—Sort the pairs into the correct sequence of how they will be terminated.

3—The normal scheme to use is 568B.

4—Trim the conductors square and to the correct length.

5—Insert the cable into the plug and ensure the conductors are fully under the pins and the jacket is under the strain relief.

6—Crimp the pins with a modular crimp tool.

7—Check all eight contacts are fully engaged and are slightly below the plastic channels.

FIGS. 6A-C illustrate the assembly process, described in steps 1-7 above.

The terms RJ-45 and RJ-11 stand for “Registered Jack-45” and “Registered Jack-11” respectively. The RJ-11 jack is a standard six-wire connector and is used in most residential homes for telephones. The RJ-45 jack resembles the RJ-11 jack, but is wider and supports more lines. It is a standard eight-wire connector and is used for data transmission or networking and most business phone systems.

They typically have pins 1-8 and use a locking clip to secure the wires to the wall jack.

These jacks provide a convenient quick disconnect mechanism which allows a user to quickly attach a device to the cabling system, or to quickly and easily replace a cable. Prior art connectors accomplished those goals very well. However, while prior art connectors perform well in a post-installation environment, their installation process requires an excessive amount of time and labor to complete. In particular, the process of attaching jacks to multi-wire cables, or installing the wall jacks which mate them, requires skilled labor to ensure that each wire is attached to the correct pin on the jack. The physical configuration of these cables has a standard color code on each pair to provide for easy identification. When attaching the wires in the cable to the jack, the technician must trim the outer coating of the cable revealing the colored coded pairs, then separate all the colored pairs and put them in an industry standard configuration then carefully attach it to the connector ensuring that the right colored wire is in the correct pin location. The process of matching the correct color-coded wire to the correct pin must be repeated for each wire that is connected to the jack. To complicate matters, the arrangement of the wires within the cable typically does not coincide with the arrangement of the pins on the connector. The misalignment of wires with their respective pin connections on the jack not only takes additional time, but it also increases the possibility of erroneously attaching a wire to the wrong pin. It would be desirable to have a method of attaching the cable wires to a cable connector, such as an RJ-11 or an RJ-45 connector in a rapid manner, with a reduced possibility for error, and without having to waste time individually matching every color to its appropriate pin.

Another time-consuming task associated with the installation of wiring within a building is the attachment of cable wires to wall jacks, such as those used to connect with a RJ-45 and RJ-11 cable connectors. As was the case with the cables themselves, a skilled craftsman is required to attach the cable wires to the back of the wall jack. Likewise, it would also be desirable to have a method of attaching the cable wires to the rear of a wall jack in a rapid and error free manner.

A common problem experienced by the prior art when attaching wires to any of the aforementioned cable jacks is that the require a substantial amount of manual labor to carefully remove the outer coating, separate the individual pairs to an industry standard and then separate the pairs and reassemble them in the order that is required, and finally route them to the appropriate connector pin.

### SUMMARY OF INVENTION

The invention provides a connector plug with an internal circuit board for rerouting the wires, and a method of attaching wires from a multi-wire cable to an RJ-45 or any other similar jack without the requirement to manually separate, sort and route individual wires to a specific pins. The invention uses the standard UTP Code as shown and described in regard to FIG. 3. The wires are attached to the connector plug in the same order that they are arranged within the cable. A circuit board with the connector plug is interposed between the pins on the connector plug, which are connected to the cable wires, and the connector pins on the other end of the connector plug which attach to wall jacks or to the device.

### BRIEF DESCRIPTION OF DRAWINGS

FIG. 1 shows the two wiring standards for cable types T-568A and T-568B.

FIGS. 2A-B illustrate the T-568A specification

FIGS. 2C-D illustrate the T-568B specification.

FIG. 3 shows the UTP color code layout of twisted wire pairs.

FIG. 4A illustrates a plug wired in a T-568B configuration.

FIG. 4B illustrates a plug wired in a T-568B configuration.

FIG. 5 illustrates the wiring connection to the back of a jack.

FIGS. 6A-E illustrate the RJ-45 assembly process.

FIG. 7A is a top view of a prior art RJ-45 Connector plug.

FIG. 7B is a bottom view of a prior art RJ-45 Connector plug.

FIG. 7C is a side view of a prior art RJ-45 Connector plug.

FIG. 7D is a distal view of a prior art RJ-45 Connector plug.

FIG. 7E is a proximal view of a prior art RJ-45 Connector plug.

FIG. 8 illustrates a cutaway top view of a preferred embodiment of the invention, which illustrates the circuit board interposed between the cable wires and the I/O connector pins.

FIG. 9A shows a side view of a prior art wall jack, which has an RJ-45 connector plug, inserted into it.

FIG. 9B shows a top view of a prior wall jack, which has an RJ-45 connector plug, inserted into it.

FIG. 9C shows a top view of a prior art wall jack, which has an RJ-45 connector plug, inserted into it. Also shown are cable wires, from a cable inside the wall, attached to the contact points on the wall jack.

FIG. 10 illustrates a side view of a preferred embodiment of a wall jack having two female connections for attachment of an RJ-45 connector plug inside the wall and an RJ-45 connector plug outside the wall.

FIGS. 11A-B illustrates an alternative preferred embodiment of the invention that provides a single connector that can be used as a T-568A or a T-568B connector.

FIG. 12 illustrates a preferred embodiment of a wall jack used with the plug provided by the invention.

FIG. 13A illustrates a side cutaway view of a preferred embodiment of the invention which shows a signal cable prior to installation in the plug.

FIG. 13B illustrates a side cutaway view of a preferred embodiment of the invention which shows a signal cable installed in the plug.

FIG. 13C illustrates an end view of the embodiment of FIGS. 13A-B. This view shows the signal cable wires prior to installation on the plug.

FIG. 13D illustrates a top view of the embodiment of FIGS. 13A-C.

FIG. 14A is a top plan view of an alternative embodiment that uses and integral switch to toggle between a T-568A connector onfiguration and a T-568B connector configuration.

FIG. 14B is a side cutaway view of the preferred embodiment of FIG. 14A which illustrates the integral switch attached to the internal circuit board.

### DETAILED DESCRIPTION

Prior to a detailed discussion of the figures, a general overview of the system will be presented. The invention provides an improved method of assembling connector's plugs, such as RJ-45 and RJ-11 to multi-wire cables. This invention applies not only to RJ-45 and RJ-11 connector plugs, but also to any other connector plug or cable type, which uses cable wires wrapped in a predetermined manner. For ease of discussion, the term “RJ-45” connector plug will be used throughout the specification to describe the principles of the invention. However, it is understood that any suitable connector plug, such as an RJ-11 will also be assembled in the same manner. The invention relates to a new connector plug, which will allow easier and faster assembly of cable wires to the connector, as described below.

Prior art cable assembly requires an excessive amount of time to attach the cable wires to a connector. A large part of the time taken to attach a connector, or to attach cable wires to a wall jack is the result of the manner in which the cable wires are arranged in relation the connectors on the jack. Currently, the cable wires, as the are arranged within the cable, do not match the pin arrangements on the connectors or jacks. As a result of this misalignment, the technician has to spend a substantial amount manually rearranging the cable wires so that the are properly aligned with the pin connectors on the jack.

Today, a skilled workman will take approximately 1:00 to 1:15 minutes to assemble the wires of an RJ-45 cable to an RJ-45 connector plug. Most of the time is consumed by the process of rearranging the color-coded wires in the cable to the proper configuration. Applicant's invention provides a substantial reduction in assembly time by eliminating the need to manually arrange the wires to the configuration required by the RJ-45 jack. In practice, it has been found that applicant's new RJ-45 connector plug allows the same skilled workman to assemble a cable to the RJ-45 connector plug in approximately 20 to 25 seconds. This timesaving over the prior art of 1:00 to 1:15 minutes for assembling a single RJ-45 connector at first glance may seem trivial. However, when installing a network cabling system throughout an office building containing hundreds, or perhaps thousands of RJ-45 connector plugs and jacks, more than 50 percent time savings provided by the invention becomes an significant competitive factor when placing bids, and has a significant impact on the time it takes to complete the installation of the network cabling. Of course, the time savings have a direct bearing on both profit, and the ability to place a winning bid.

In addition to drastically reducing assembly time, the straightforward approach allowed by applicants modified RJ-45 connector plug and wall jack reduces the changes for error by the workman, which further saves time and increases profits.

The invention takes advantage of the fact that when multi-wired cables are fabricated, the wires are twisted into a preset order. In particular, when the outer cover is removed from a CAT-3, 4,5,6 cable the twisted pairs inside the cable are arranged in a predetermined order. The invention provides a method of attaching the twisted pairs to the RJ-45 connector plug and jacks in that order, thereby it eliminates the need to manually separate and arrange the wires to attach to there corresponding point within the RJ-45 connector as done in the prior art.

The new RJ-45 connector plug provided by the invention includes a circuit board, which is interposed between the wires in the cable and the I/O connector pins on the RJ-45 connector plug. The wires in the cable are attached to the circuit board in the same manner that they are arranged within the cable. This eliminates the need to manually arrange the wires. The circuit board is also attached, at it other end, to the I/O connector pins on the RJ-45 connector plug. In turn, the land patterns on the circuit board are laid out such that they automatically reroute the signal lines that the wires attach to the circuit board are electrically connected to the correct I/O connector pin on the RJ-45 jack.

We now turn to a more detailed discussion of the figures.

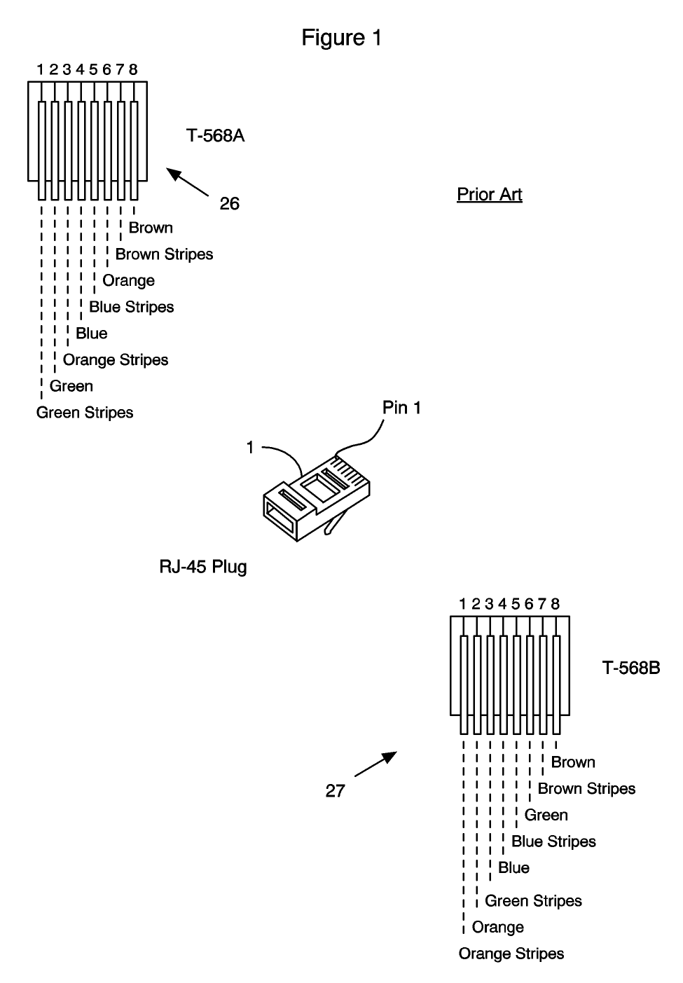

FIG. 1 shows the two prior art wiring standards for cable types T-568A and T-568B. Configuration 26 shows the wiring configuration for a T-568A plug, and configuration 27 illustrates the wiring configuration for a T-568B plug. Both configurations use a conventional RJ-45 plug 1.

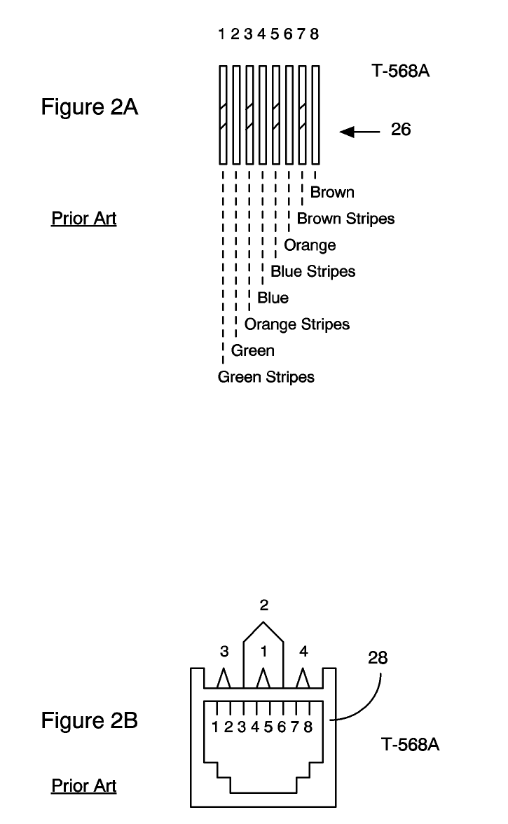

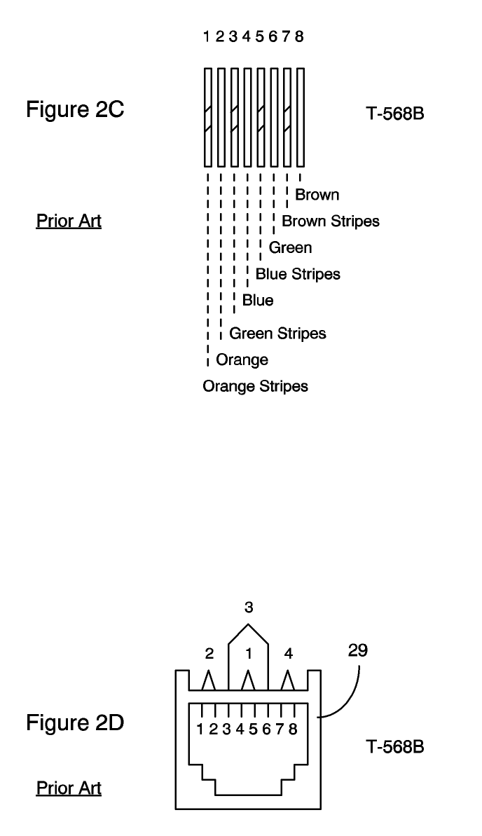

FIG. 2A illustrates a prior art T-568A configuration 26. Also shown, in FIG. 2B, is jack 28 which uses wire pairs 1-4 as illustrated.

FIG. 2C illustrates a prior art T-568B configuration. This configuration uses jack 29, which has wire pairs 1-4 configured as shown.

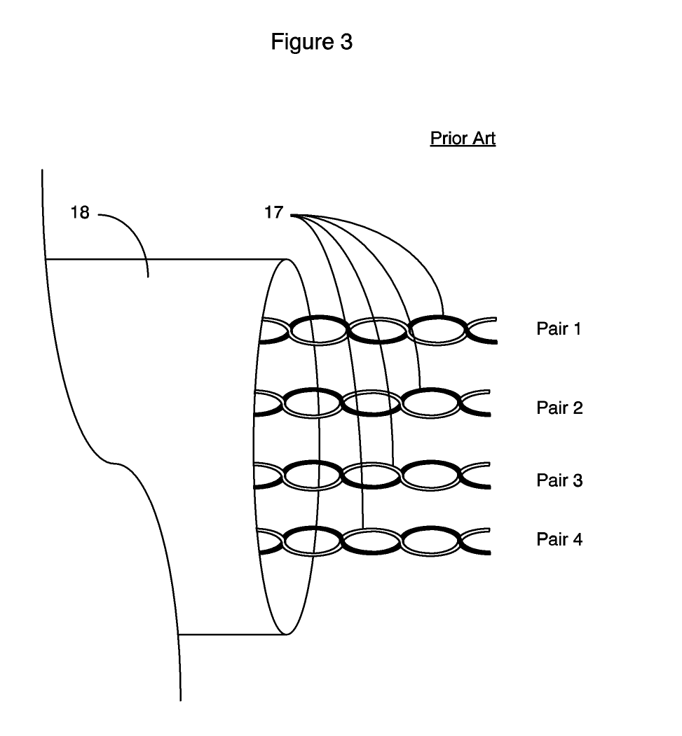

FIG. 3 shows a prior art UTP color code layout of twisted wire 17 pairs. Each pair has specific marking colors and is always physically disposed in the cable 18 in the same order. The invention, as discussed in more detail below, takes advantage of this consistent arrangement of wire leads 17 within cable 18.

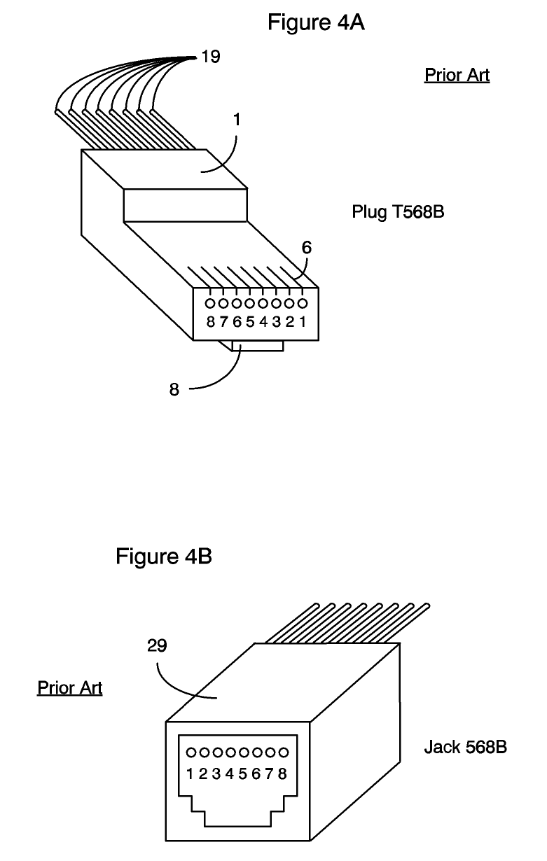

FIG. 4A illustrates a prior art plug 1 in a T-568B configuration. Also shown are leads 19, signal connectors 6, and release lever 8.

FIG. 4B illustrates a prior art jack 29 in a T-568B configuration.

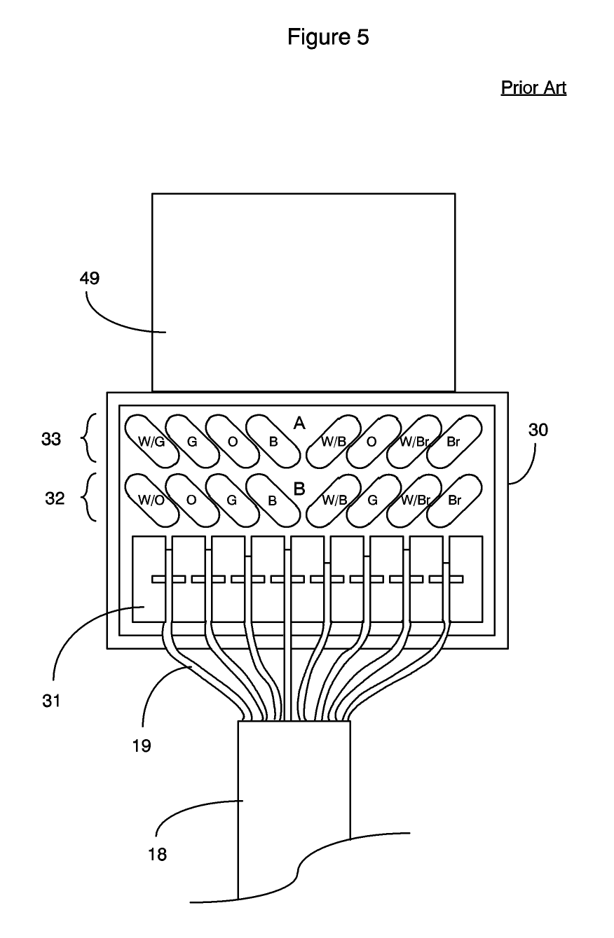

FIG. 5 illustrates the wiring connection to the back panel 30 of a prior art wiring jack. This figure shows connectors 31 securing wires 19 of cable 18. Also shown are color maps 32-33 which list colors associated with jack types T-458B and T-458A, respectively. Panel cover 49 is also shown.

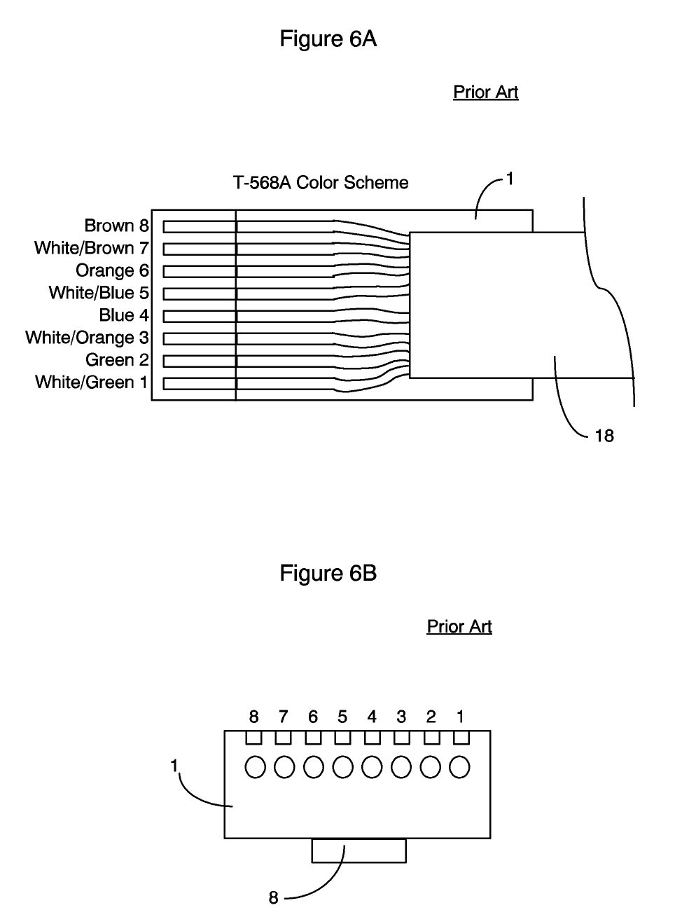

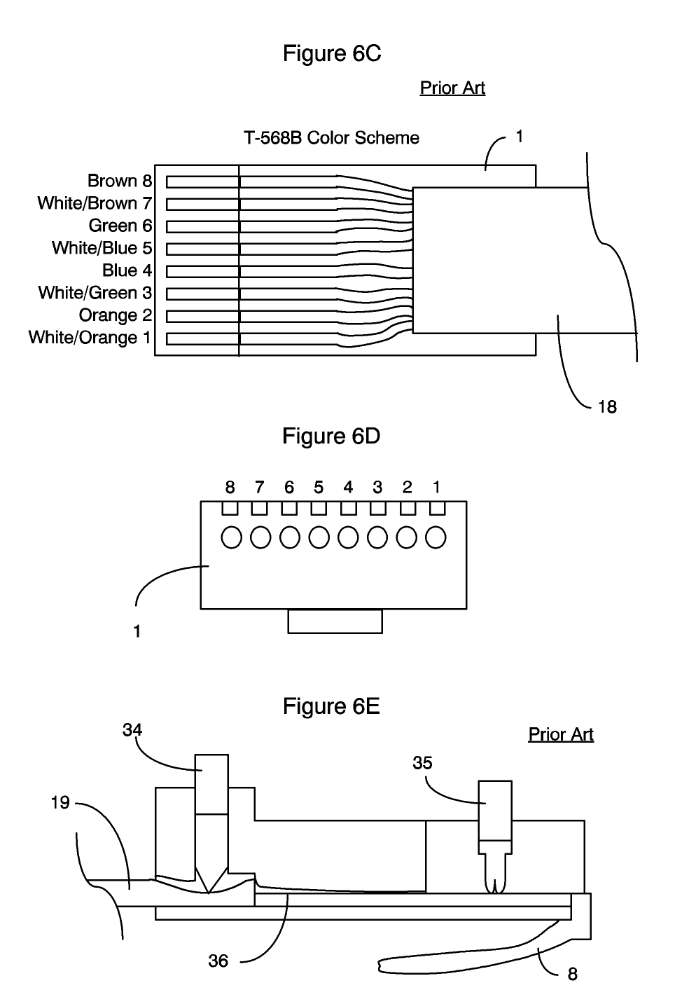

FIGS. 6A-E illustrate a prior art RJ-45 assembly process. In FIG. 6A, the wires from cable 18 are arranged in order for a T-568A plug. FIG. 6B illustrates the layout of wires on the distal end of jack 1. FIGS. 6C-D illustrate the layout of cable wires for a T-568B plug.

FIG. 6E is a side cutaway view of a prior art plug which illustrates a wire 19 secured by clamp 34, with the stripped end 36 secured by clamp 35.

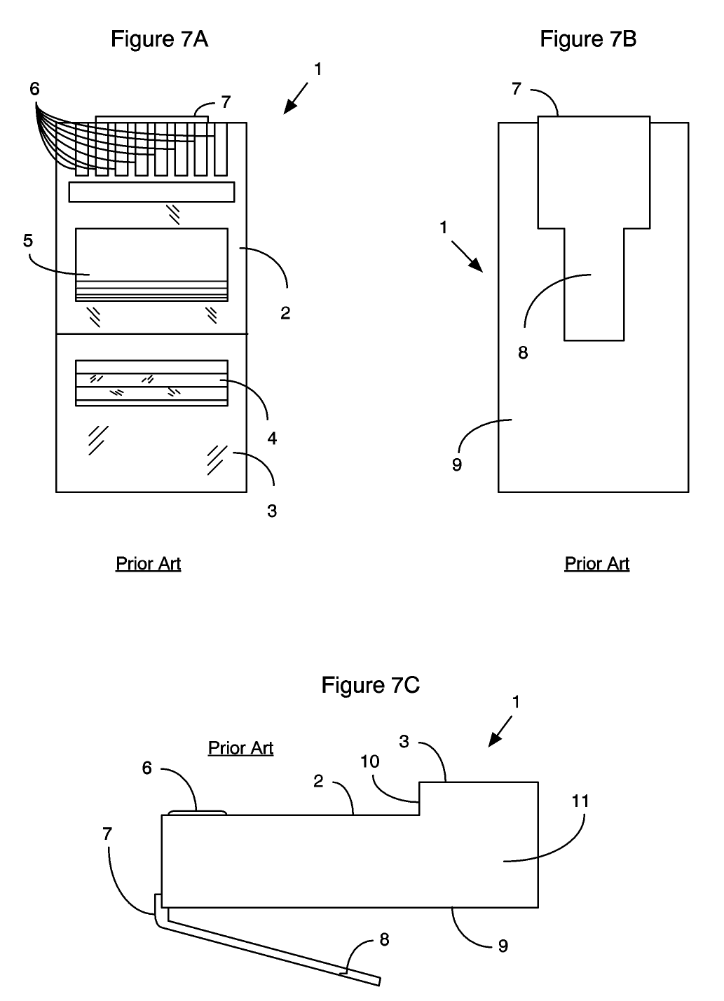

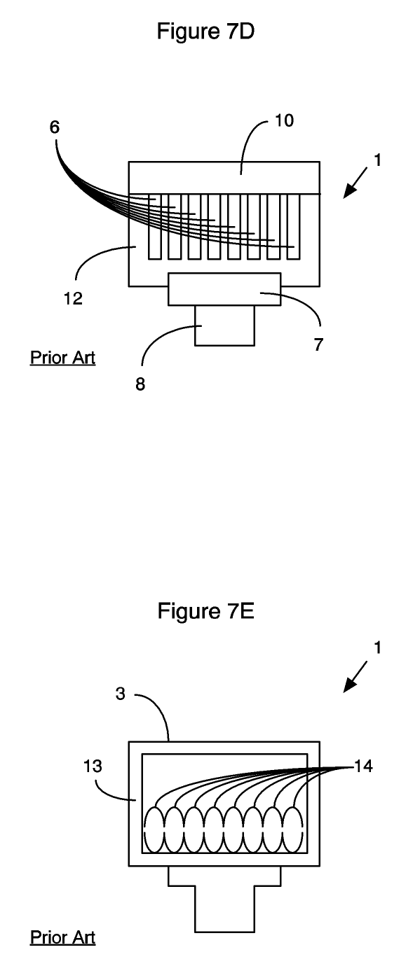

FIG. 7A is a top view of the prior art of a RJ-45 connector plug 1. It shows a series of eight I/O connector pins at the distal end of the RJ-45 connector plug 1. Also shown are the distal edge 7 of the retaining clip 8 (shown in FIG. 1B), the lower distal surface 2, the upper proximal surface 3, the retaining clip 4, and a curved guide 5 which is used to guide the cable wires to there associated I/O connector pins 6. It is a typical structure for a conventional RJ-45 connector plug. Likewise, the RJ-11 jack used for telephone cabling has a substantially similar design with the exception that it uses fewer wires.

FIG. 7B is a bottom view of a prior art RJ-45 connector plug 1. This view illustrates the bottom surface 9 of the RJ-45 jack 1. In addition, retaining clip 8 is also shown extending form the distal edge 7.

FIG. 7C is a side view of a prior art RJ-45 connector plug 1. This view illustrates the lower distal surface 2, the upper proximal surface 3, the upper wall 10, the side surface 11, the retaining clip 8, and the associated distal edge 7, and the I/O connector pins 6.

FIG. 7D is a distal end view of a prior art RJ-45 connector plug 1. This view illustrates the I/O connector pins 6 which extend across the upper portion of the distal surface 12. Upper wall 10 and distal edge 7 and the associated retaining clip 8 are also shown.

FIG. 7E is a proximal end view of a prior art RJ-45 connector plug 1. This view illustrates the proximal edge 13, the upper proximal surface 3, and the wire guides 14. When wires from the cable are inserted into a prior art RJ-45 connector plug 1, the wire guides 14 routes each wire such that they are positioned directly to the I/O pins 6. Once positioned in this manner, the I/O connector pins are clamped down on top of the wires to secure them directly to the I/O pins 6. Of course, in order to complete the assembly of the RJ-45 connector plug 1, the technician must take the time to carefully rearrange the wires at the end of the cable, and then carefully insert them into the guide 14 of the RJ-45 connector plug 1.

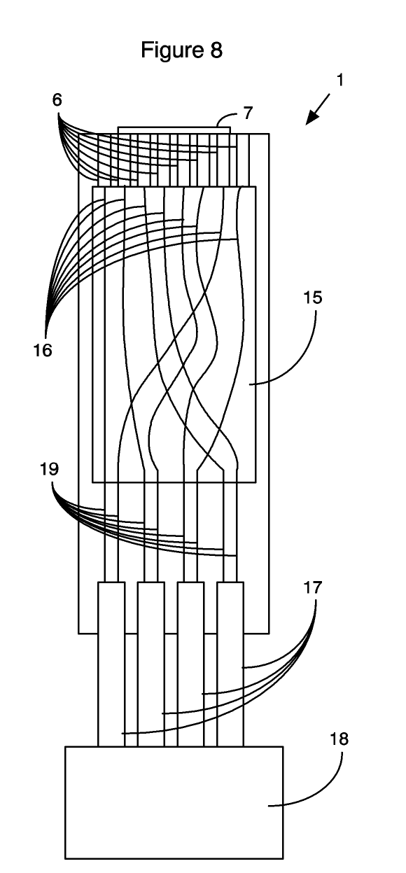

FIG. 8 illustrates a cutaway top view of a preferred embodiment of the new RJ-45 connector plug 1. This figure shows the circuit board 15 interposed between the cable wires 19 and the I/O connector pins 6. When the cable 18 is attached to the RJ45 connector plug 1, the of the outer cover 18 is stripped to reveal the four pairs of wires 17. The four pairs of wires 17 contain two wires 19 which are associated with one another. Each pair of wires 17 are intended to be attached to a specific I/O connector pins 6 on the RJ-45 connector plug 1. In a prior art RJ-45 connector plug 1, the technician would have to manually route the wires 19 and secure them directly to the I/O connector pins 6. Using this new RJ-45 connector plug 1, the technician merely uses the wire pairs 17 as the are normally ordered within the cable 18 attaches each pair of wires 19 within wire pair 17 to the circuit board 15. The circuit board 15 is preconfigured to route the signals from the wires 19 to the correct I/O connector pin 6. This routing is preformed by land patterns 16 on the circuit board 15 which have been preconfigured. As a result, the technician only needs to strip the outer cover an appropriate length of the shielding, attach the wires to the circuit board in there natural order, crimp, and the RJ-45 connector plug 1 is complete.

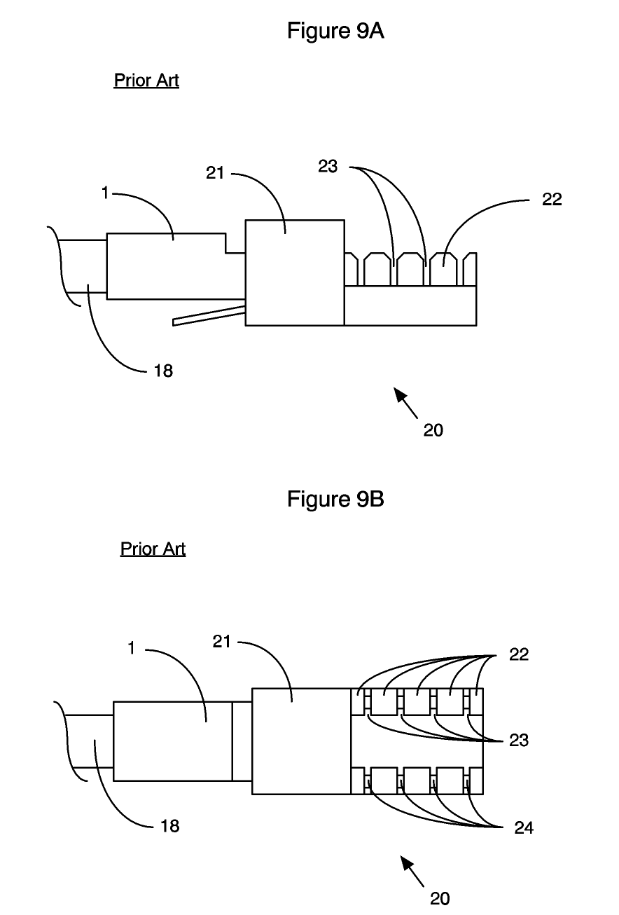

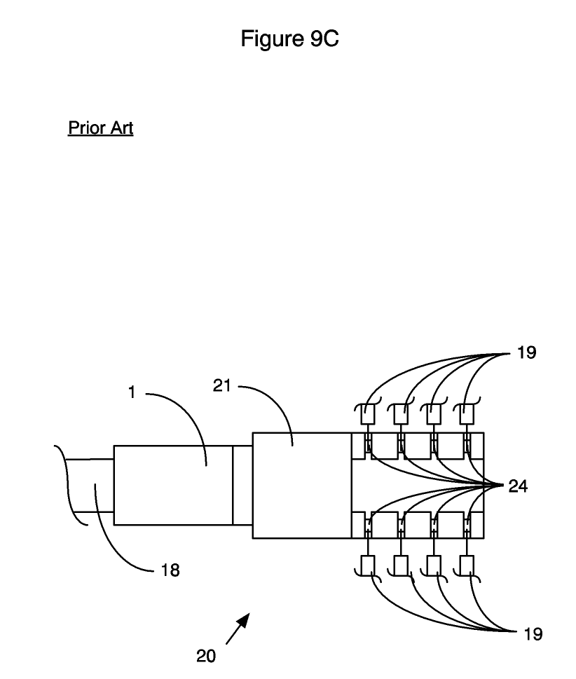

FIG. 9A shows a side view of a prior art wall jack 21, which has a RJ-45 connector plug 1, inserted into it. This figure, in conjunction with FIGS. 3B-C, illustrates how prior art wall jacks have the same assembly disadvantages that the RJ-45 connector plug 1 has. This figure illustrates a prior art wall jack 21, which has a number of wire separators 22 which define a series of wire slots 23. When installing wiring throughout a building, the cables 18 are routed to the location of the wall jack 21, which has a number of wire separators 22 which define a series of wire slots 23. When installing wiring throughout a building, the cables 18 are routed to the location of the wall jack 21. Once the walls have been finished and the wall jacks 21 are ready to install, the workman simply attaches the new RJ-45 connector plug to the female end of the coupler.

FIG. 9B shows a top view of a prior art wall jack, which has an RJ-45 connector plug, inserted in it.

FIG. 9C shows a top view of a prior art wall jack, which has an RJ-45 connector plug, inserted into it. Also shown are cable wires, from a cable inside the wall, attached to contact points on the wall jack.

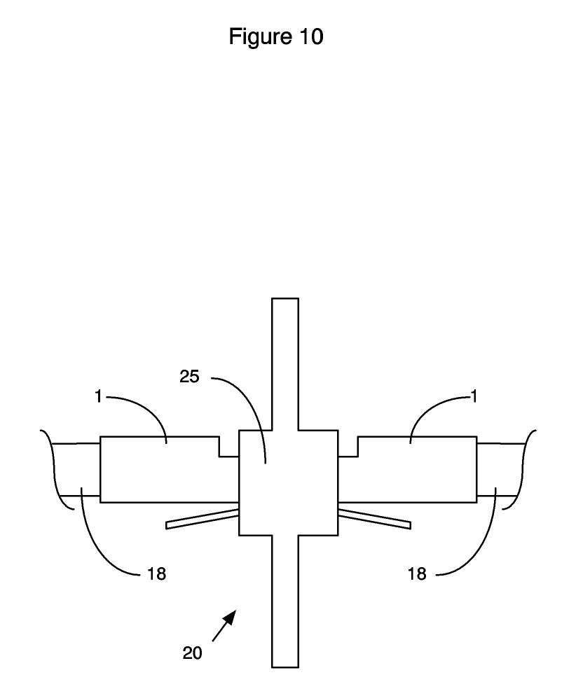

FIG. 10 illustrates a side view of a preferred embodiment of a wall jack having two female connections for attachment of an RJ-45 connector plug inside the wall and an RJ-45 connector plug outside of the wall.

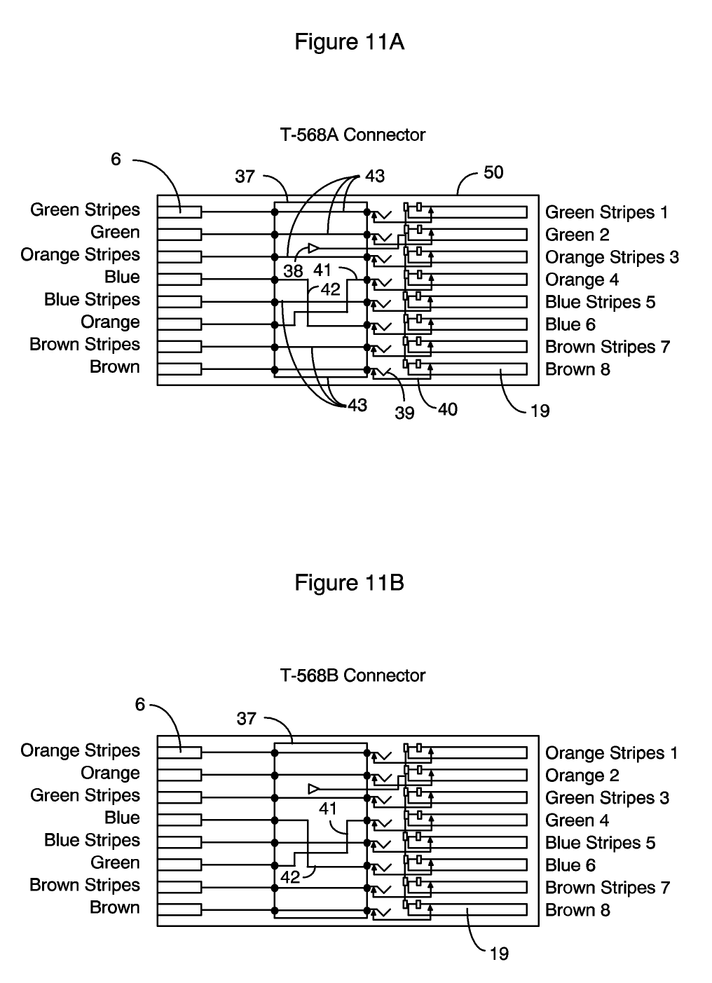

FIG. 11A-B illustrate an alternative preferred embodiment that allows a single jack 50 to be used for either a T-568A or a T-568B configuration. This is accomplished a rerouting two wires 41, 42 on circuit board 37 which is an integral component of jack 50. Signal wires 19 enter jack 50 and connect to circuit board 37 via contacts 39. Six of the signal lines 43 are routed directly through to output contacts 6. By rerouting lines 41, 42 as shown in the figures, the installer only needs to reverse the orange and green leads to allow the same plug to be used for both T-568A and T-568B plugs. This simplifies the installation process and only requires a single plug type to be stocked.

The plug used in this embodiment also has an optional LED 38 that signals when a contact is open. LED 38 is activated by shunt line 40 when contact 39 is open.

FIG. 12 is a preferred embodiment of a wall jack 20. This embodiment uses a double female connector that allows plus 1 or 50 to be attached. It also has an optional LED 38 to indicate a connection failure.

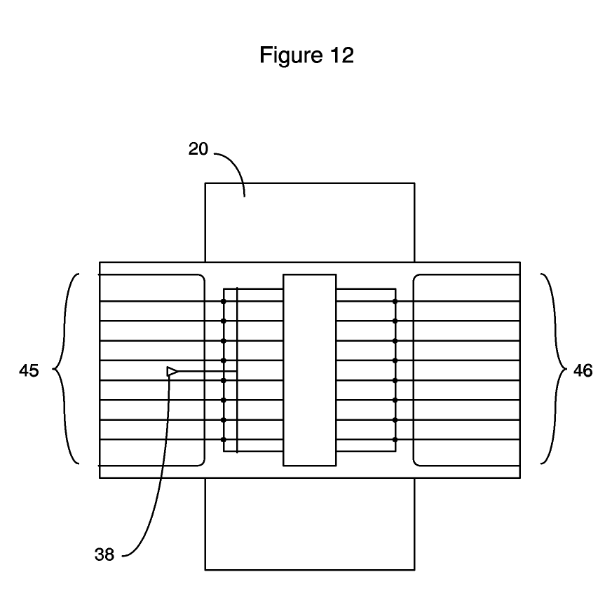

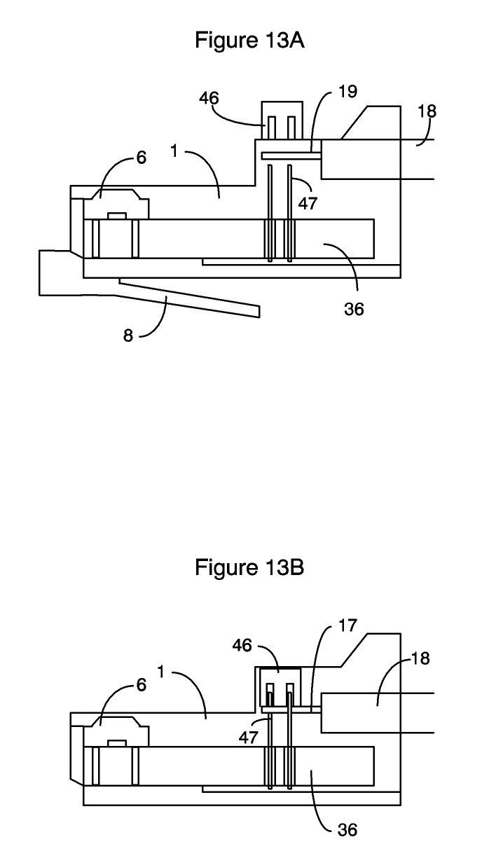

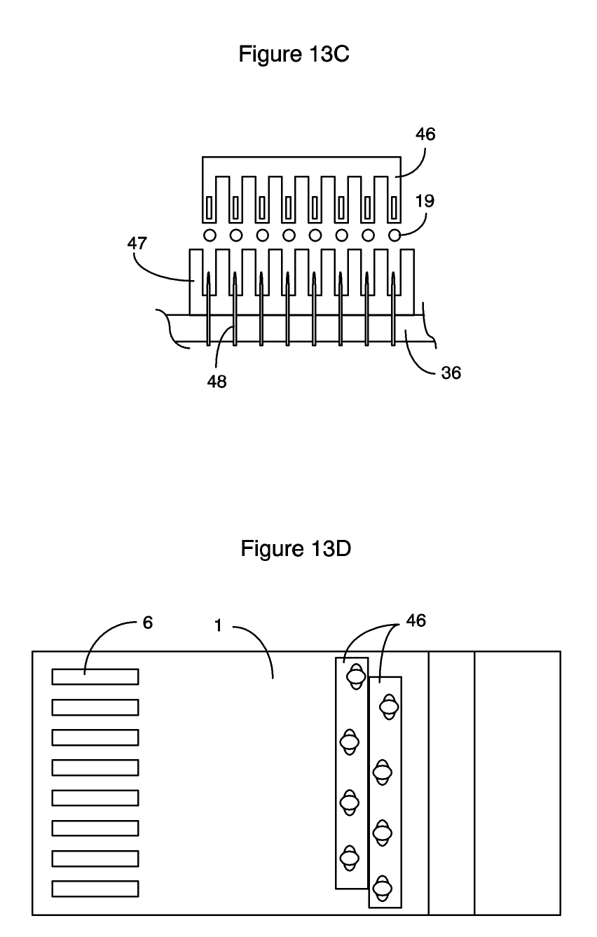

In FIG. 13A, a side cutaway view of another alternative embodiment of plug 1 is shown. In this embodiment, signal cable 18 is shown inserted into plug 1, but it has not been secured. Connection points 47 are shown below the wires 19 of cable 18, In addition, clamp 46 is shown in the retracted position.

FIG. 13B illustrates a side cutaway view of the embodiment of FIG. 13A with the wires secured to connection points 47 by clamp 46. Connection points 47 are in turn secured to circuit board 36 via pins 48 (shown in FIG. 13C). Also secured to circuit board 36 are output contacts 6.

FIG. 13C illustrates how the wires 19 are inserted into the plug when the clamp 46 is in the retracted position. In this figure, the wires 19 are inserted in the plug with each wire 19 arranged above a pin 48. The pins 48 are in turn electrically attached to circuit board 36 and provide the connection path between the wires 19 and the internal circuit board 36 of the plug 1.

FIG. 13D is a top view of the embodiment of FIGS. 13A-C. As can be seen from this figure, the connection points 47 are offset from adjacent connection points 47. This allows larger connection points 47 to be used without interfering with one another.

As can be seen from the forgoing, the invention takes advantage of the fixed arrangement of wires inside the cable to reduce the time necessary to attach the cable to a plug. By saving installation time, the cost of installation is reduced. This saves expense on the part of the owner and increases the profit of the installer. In one embodiment, the wires are installed in the exact order the are arranged within the cable. This eliminates the time used in the prior art to sort and arrange the wires prior to assembly of a plug. In another embodiment, the same plug can be used for both T-568A and T-568B configurations.

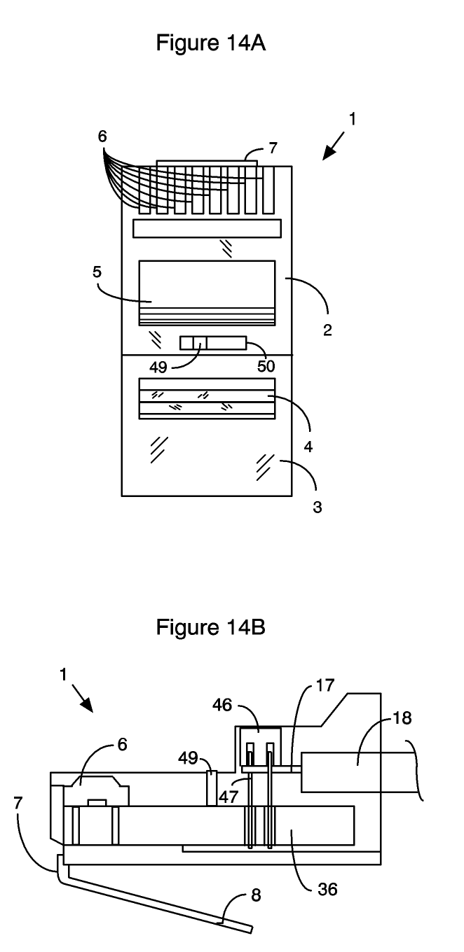

In FIG. 14A, another alterative preferred embodiment is shown. In this embodiment, an integral switch 49 is shown mounted in a switch channel 50. This embodiment uses a circuit board 36 that is wired such that, when placed in a first position, it routes signals to the output connectors 6 in a T-568A configuration. When the integral switch 49 is moved from the first position to the second position, it switches the signal line routing such that the signals are output to the output connectors 6 in a T-568B configuration. As a result, the same switch can be used to switch between either configuration.

The integral switch shown in FIG. 14A is intended to illustrate the use of a switch to alternate between configurations. Those skilled in the art will recognize that switches are well known in the art, and that any suitable type of switch can be used to accomplish configuration switching.

FIG. 14B is a side cutaway view of the embodiment of FIG. 14A. This figure illustrates switch 49 attached to circuit board 36.

While the invention has been described with respect to a preferred embodiment thereof, it will be understood by those skilled in the art that various changes in detail may be made therein without departing from the spirit, scope, and teachings of the invention. For example the material used to construct the connectors, receptacles, and cables can vary. The type and number of data lines can vary, etc. Accordingly, the invention herein disclosed is to limited only as specified in the following claims.

1. A cable plug, comprising:
a plurality of input connectors;
a plurality of output connectors;
means to attach at least a portion of the wires in a cable having a predetermined wire configuration to the input connectors such that electronic signals from the cable are input to the input connectors in a first preselected configuration; and
rerouting means to electrically connect at least a portion of the input connectors to at least a portion of the output connectors such that the output connectors output the electronic signals in a second preselected configuration;
whereby the plug can be rapidly assembled to a cable by attaching the cable wires in their predetermined wire configuration to a plug and rerouting the cable wires to a second preselected configuration at the output of the cable plug.

2. A plug, as in claim 1, wherein the rerouting means is a circuit board that reorders the arrangement of wires such that wires attached to specific input connectors of the plug are routed to specific output connectors of the plug.

3. A plug, as in claim 2, wherein the plug is an RJ11 plug.

4. A plug, as in claim 2, wherein the plug is an RJ45 plug.

5. A plug, as in claim 4, wherein the output connector is configured in a T-568A or a T-568B configuration.

6. A plug, as in claim 2, further comprising a switch, the switch attached to the circuit board such that the configuration of the output connectors can be changed from a first configuration to a second configuration by moving the switch from a first position to a second position.

7. A plug, as in claim 6, wherein the first configuration a T-568A configuration and the second configuration is a T-568B configuration.

8. A plug, as in claim 1, wherein the rerouting means is discrete wiring that reorders the arrangement of wires such that wires attached to specific input connectors of the plug are routed to specific output connectors of the plug.

9. A plug, as in claim 8, wherein the plug is an RJ11 plug.

10. A plug, as in claim 8, wherein the plug is an RJ45 plug.

11. A plug, as in claim 10, wherein the output connector is configured in a T-568A or a T-568B configuration.

12. A cabling system, comprising:
a multi-wire data cable having wires arranged in a predetermined order; and
a plug assembly, further comprising;
a plurality of input connectors;
a plurality of output connectors;
means to attach at least a portion of the wires in the cable to the input connectors such that electronic signals from the cable are input to the input connectors in a first preselected configuration; and
rerouting means to electrically connect at least a portion of the input connectors to at least a portion of the output put connectors such that the output connectors output the electronic signals in a second preselected configuration;
whereby the plug can be rapidly assembled to the cable by attaching the cable wires in their predetermined wire configuration to a plug and rerouting the cable wires to a second preselected configuration at the output of the cable plug.

13. A system, as in claim 12, wherein the rerouting means is a circuit board that reorders the arrangement of wires such that wires attached to specific input connectors of the plug are routed to specific output connectors of the plug.

14. A system, as in claim 13, wherein the plug is an RJ45 plug.

15. A system, as in claim 14, wherein the output connector is configured in a T-568A or a T-568B configuration.

16. A system, as in claim 13, further comprising a switch, the switch attached to the circuit board such that the configuration of the output connectors can be changed from a first configuration to a second configuration by moving the switch from a first position to a second position.

17. A system, as in claim 16, wherein the first configuration a T-568A configuration and the second configuration is a T-568B configuration.

18. A method of rapidly assembling a plug to a data cable, including the steps of:
spreading the wires in a data cable into a predetermined order in which they are arranged inside the data cable;
attaching the wires to the input connectors of a plug such that signals on the wires are input to the input connectors in the predetermined order;
rerouting signals between the input connectors and the output connectors, inside the plug, such that the order of the signals at the output connectors are in a second predetermined order.

19. A method, as in claim 18, including the additional step of using a circuit board to reroute the signals.

20. A method, as in claim 19, including the additional step of using a switch to alter the configuration of the output connections from a first configuration to a second configuration.
